(19) United States
(12) Patent Application Publication
(10) Pub. No.: US 2024/0170713 A1
(43) Pub. Date: May 23, 2024

(54) BATTERY CELL COMPRISING CASE FOR BULGING REDUCTION AND BATTERY DEVICE COMPRISING THE SAME

(71) Applicant: SK ON CO., LTD., Seoul (KR)

(72) Inventors: John Cronin, Jericho, VT (US); So Yeon YANG, Daejeon (KR); Soo Min PARK, Daejeon (KR); Hyung Ju PAIK, Daejeon (KR); Hae Ryong JEON, Daejeon (KR)

(21) Appl. No.: 18/352,087

(22) Filed: Jul. 13, 2023

Related U.S. Application Data
(60) Provisional application No. 63/427,671, filed on Nov. 23, 2022.

(51) Int. Cl. H01M 10/04; H01M 50/224; H01M 50/242

(52) U.S. Cl. CPC H01M 10/0468; H01M 10/0431; H01M 10/0486; H01M 50/224; H01M 50/242

(57) ABSTRACT

A battery cell including an electrode assembly and a case accommodating the electrode assembly is provided. The case includes a plurality of corner portions and a planar portion disposed between the plurality of corner portions, and the planar portion is configured to press the electrode assembly, when the electrode assembly swells.

This patent document claims the benefit of U.S. Provisional Patent Application No. 63/427,671 filed on Nov. 23, 2022, the disclosure of which is incorporated herein by reference in its entirety.

### BACKGROUND

The present disclosure relates to a battery cell including a case for bulging reduction and a battery device including the same. More specifically, the present document relates to a prismatic battery cell and a battery device including a case capable of improving strength and stability of the battery cell.

A battery cell includes an electrode assembly and a case accommodating the electrode assembly. In prismatic battery cells, bulging problems may occur when excessive heat and pressure are accumulated inside a can. For example, a battery cell and a battery device including the battery cell may be damaged due to swelling of the electrode assembly. In order to prevent damage due to bulging of the battery cell, a structure of the battery cell for enhancing durability of the battery cell has been researched.

### SUMMARY

A battery cell may include an electrode assembly and a case accommodating the electrode assembly. The case may be made of a can, to protect the electrode assembly from external impacts. Strength and weight of a case are trade-offs. As the case is formed to be thinner to reduce the weight of the battery cell, the strength of the case may be reduced. When swelling occurs in the electrode assembly, the case may be easily modified (e.g., bulging) as the strength of the case decreases.

An aspect of the present disclosure is to provide a battery cell including a case for preventing bulging and a battery device including the same.

According to an aspect of the present disclosure, a battery cell includes an electrode assembly and a case accommodating the electrode assembly. The case may include a plurality of corner portions and a planar portion disposed between the plurality of corner portions. The planar portion may be configured to press the electrode assembly, when the electrode assembly swells.

According to an embodiment, the case may include at least one support sleeve forming at least a portion of the planar portion.

According to an embodiment, the at least one support sleeve may include steel.

According to an embodiment, the planar portion may include a reinforcing portion protruding toward the electrode assembly.

According to an embodiment, the case may be manufactured by an impact extrusion process using a driving slug including a cutout.

According to an embodiment, the planar portion may include an ironing region and a protrusion extending from the ironing region and protruding outwardly of the case.

According to an embodiment, a thickness of at least a portion of the planar portion may be greater than a thickness of each of the plurality of corner portions.

According to an embodiment, the case may include a wide surface and a narrow surface. At least a portion of the wide surface may be configured to press the electrode assembly, when the electrode assembly swells.

According to an aspect of the present disclosure, the battery cell may include an electrode assembly and a case accommodating the electrode assembly. The case may include a plurality of corner portions and a planar portion disposed between the plurality of corner portions. A first thickness of the corner portion may be greater than a second thickness of the planar portion.

According to an embodiment, the corner portion may include a plurality of support rods.

According to an embodiment, the corner portion may include a plurality of support rods.

According to an embodiment, the case may be manufactured by an impact extrusion process using a driving slug having a corner deformation portion.

According to an embodiment, the case may include an ironing region formed on the planar portion, and a reinforcing region forming at least a portion of the corner portion and is thicker than the ironing region.

According to an embodiment, the buffer portion may include a first buffer portion and a second buffer portion located in parallel with the first buffer portion. A first distance between the first buffer portion and the second buffer portion may be shorter than a second distance between the plurality of corner portions.

According to an embodiment, the case may include a wide surface and a narrow surface, and the buffer portion may be formed on the wide surface.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is an exploded perspective view of a battery cell according to an embodiment;

FIGS. 2A, 2B, and 2C are views for illustrating an upper cap assembly according to an embodiment;

FIGS. 3A to 3F are a view for illustrating an assembly process of an upper cap assembly and an electrode assembly according to an embodiment;

FIGS. 4A TO 4F are a view for illustrating an assembly process of an electrode assembly, a jelly roll bag, and a can according to an embodiment;

FIG. 5 illustrates a bulging can, according to an embodiment;

FIG. 6 is a diagram for illustrating a manufacturing process of a battery cell according to an embodiment;

FIGS. 7A and 7B are views for illustrating an impact extrusion process according to an embodiment.

FIGS. 8A and 8B are a diagram for illustrating an ironing process according to an embodiment;

FIG. 9 illustrates a can including a support rod, according to an embodiment.

FIG. 10 illustrates a can including a support sleeve, according to an embodiment;

FIG. 11 illustrates a battery cell including a protective bag, according to an embodiment;

FIG. 12 illustrates a can including a protruding region, according to an embodiment.

FIG. 13 illustrates a can including a modified corner portion, according to an embodiment;

FIG. 14 illustrates a can formed by a first ironing process, according to an embodiment;

FIG. 15 shows a can formed by a second ironing process, according to an embodiment; and

FIGS. 16A and 16B are schematic diagrams of a battery cell, according to an embodiment.

### DETAILED DESCRIPTION

Embodiments of the present disclosure will be more fully described below with reference to the accompanying drawings, in which like symbols indicate like elements throughout the drawings, and embodiments are shown. However, embodiments of the claims may be implemented in many different forms and are not limited to the embodiments described herein. The examples given herein are non-limiting and only examples among other possible examples.

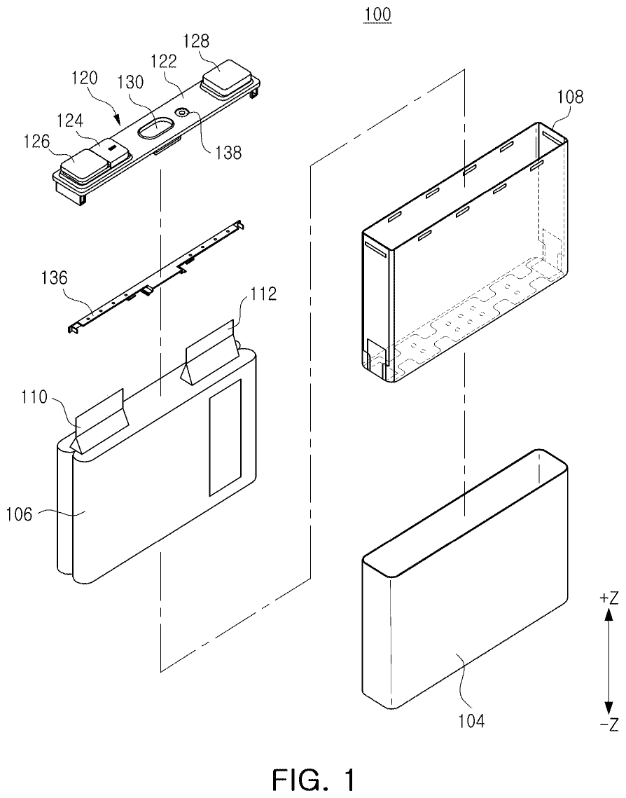

FIG. 1 is an exploded perspective view of a battery cell according to an embodiment.

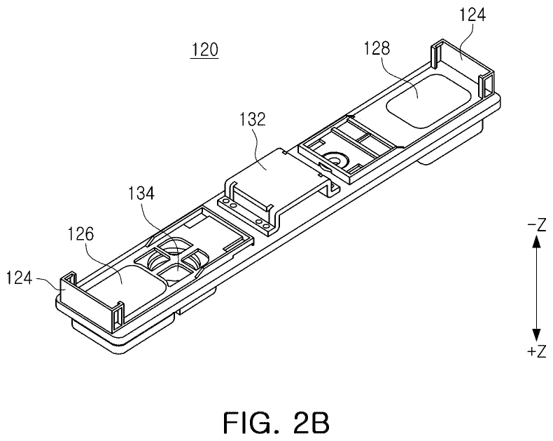

Referring to FIG. 1, a battery cell 100 may be a prismatic cell. Prismatic cells are widely used in powertrains of electric vehicles. The prismatic cells may be stacked together in a rectangular shape, allowing more efficient use of space. Prismatic cells are generally rectangular and have a higher power density than cylindrical cells. Prismatic cells also provide better performance in cold weather and less damage from vibration. However, prismatic cells may be more expensive to manufacture than cylindrical cells. In addition, prismatic cells are less likely to fail due to vibration or movement. Prismatic cells may deliver more power than cylindrical battery cells due to spatial optimization of the rectangular shape thereof. The prismatic battery cell 100 includes a rectangular can 104 that may be formed of steel, aluminum, aluminum alloy, plastic, or other metals having sufficient structural strength. The can 104 may be manufactured according to various different methods including deep draw or impact extrusion. The method for manufacturing the can 104 may be combined with wall ironing to achieve the final geometry, thickness and tolerances. The can 104 may be wrapped with cell cover tape. A jelly roll 106 includes a stacked anode, cathode and separator. A jelly roll 106 type electrode assembly configured to have a structure of a long sheet type cathode and a long sheet type anode to which an active material is applied is wound. At the same time, the stacked-type electrode assembly has a structure in which a separator is disposed between a cathode and an anode or has a structure in which a plurality of cathodes and anodes having a predetermined size are sequentially stacked and a separator is disposed between each of the cathodes and the anode. The jelly roll-type electrode assembly is easy to manufacture and has high unit mass and energy density, compared to a sheet-type electrode assembly. In some batteries, one or more jelly rolls 106 are inserted into can 104. Each jelly roll 106 electrode assembly is included inside a polymer jelly roll bag 108 sealed inside the can 104. Each jelly roll 106 includes a cathode foil 112 formed of aluminum. The aluminum foil is coated with the electrode slurry. A first operation of electrode manufacturing is a slurry mixing process in which an active raw material is combined with a binder, a solvent and an additive. This mixing process should be performed separately for anode and cathode slurries. Viscosity, density, solids content and other measurable properties of the slurry affect battery quality and electrode uniformity. For example, a slurry having a faster drying rate, a higher solids content, a lower rate capability, and a low viscosity is generated as a solvent content is higher. Thereafter, the cathode slurry is applied to an aluminum foil and dried. A slot die coater is a method of coating a foil in which a slurry is spread through slot gaps on the moving foil receiving tension over rollers. In some embodiments, this may be performed simultaneously on both sides of the foil. This production method enables high speed, while achieving precision in coating thickness. A drying process may be incorporated into a continuous coating. The drying process should achieve three objectives: diffusion of the binder, sedimentation of particles, and evaporation of the solvent. Air floatation is a method of drying the slurry on the foil. Uniformity of the electrode coating and drying process affects the safety, consistency and life cycle of the prismatic battery cell 100. The electrode should go through a calendaring process in which electrode porosity and twist are controlled by compressing the coated electrode sheet to a uniform thickness and density. Each jelly roll 106 includes an anode foil 110 formed of copper foil. The anode foil 110 is provided similarly to a cathode foil 112. Each jelly roll 106 may include a cathode connector (not shown) that makes an electrical connection between the inner end portion of the cathode foil 112 and the cathode terminal 128. Each jelly roll 106 may include an anode connector (not shown) that makes an electrical connection between the inner end portion of the anode foil 110 and an anode terminal 126. Each jelly roll 106 may include a cathode connector mask (e.g., a cathode connector mask 118 in FIG. 3C).

Each prismatic battery cell 100 may have an upper cap assembly 120 welded or otherwise bonded to the top of the can 104. The upper cap assembly 120 may include a base plate 122 attached to the can 104. The base plate 122 isolates the inside and outside of the cell by welding with the can 104. The base plate 122 may serve as a rigid support structure for elements within the upper cap assembly 120. The upper cap assembly 120 may include a plurality of upper insulators 124 to insulate the base plate 122. The upper insulator 124 may prevent leakage of an electrolyte from the prismatic battery cell 100. Additionally, the upper insulator 124 may isolate the can 104 from the cathode foil 112 and prevent penetration of moisture and gases from the outside of the cell. A portion of the upper insulator 124 may protect a current interrupting device. The upper cap assembly 120 includes a cathode terminal 128 electrically connecting the inside and outside of the prismatic battery cell 100. The upper cap assembly 120 includes an anode terminal 126 electrically connecting the inside and outside of the prismatic battery cell 100.

The upper cap assembly 120 may include a vent 130 allowing exhaust gases from the prismatic battery cell 100 to be discharged in a controlled direction and at a controlled pressure. The upper cap assembly 120 may include a vent guard 132 protecting the vent 130 from the inside of the prismatic battery cell 100 in order to prevent the vent 130 from malfunctioning. The upper cap assembly 120 may include an overcharge safety device 134 preventing an external current from being introduced using an internal gas pressure of the prismatic battery cell 100. The upper insulator 124 may be multi-component. In some embodiments, side portions of the upper insulator 124 may be mounted on the edges of the can 104 and the upper cap assembly 120. An electrolyte cap 138 may seal an electrolyte solution inside the prismatic battery cell 100.

The battery cell 100 may include an insulator 136 located between the upper cap assembly 120 and the can 104.

In this document, the electrode assembly of the battery cell 100 is described as the jelly roll 106, but the electrode assembly of the battery cell 100 is not limited to the jelly roll 106. For example, the jelly roll 106 may be replaced with a stack type electrode assembly or a Z-folding type electrode assembly. According to an embodiment, the jelly roll 106 described herein may refer to an electrode assembly.

In this document, the can 104 may be referred to as a case or housing.

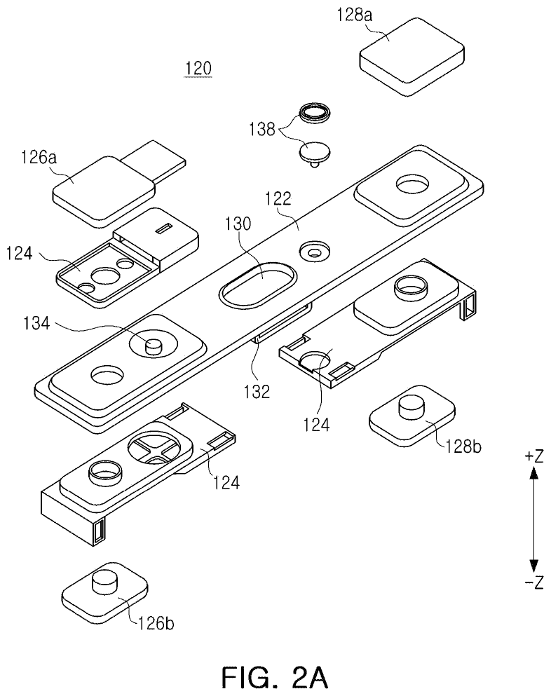

FIGS. 2A, 2B and 2C show a configuration and component functions of the upper cap assembly 120. For example, FIG. 2A is an exploded perspective view of the upper cap assembly 120 according to an embodiment of the present disclosure. FIG. 2B is a rear perspective view of the upper cap assembly 120 according to an embodiment of the present disclosure. Description of the upper cap assembly 120 of FIG. 1 may be applied to the upper cap assembly 120 of FIGS. 2A, 2B and 2C.

The upper cap assembly 120 serving as a cover for the prismatic battery cell 100 is a complex assembly including a plurality of welded components. Adhesives may be used instead of welding specific components.

The prismatic battery cell 100 may include the vent 130. The vent 130 provides overpressure alleviation when temperature and corresponding pressure increase in the prismatic battery cell 100. For example, the vent 130 may be activated in a pressure range of 10 to 15 bar. The vent 130 may be laser-welded to the upper cap assembly 120.

The prismatic battery cell 100 may include the can 104. The can 104 may generally be formed of deep-drawn aluminum or stainless steel to prevent moisture from entering the cell, while providing diffusion resistance to organic solvents, such as liquid electrolytes. The most important reason the can 104 is typically formed of deep-drawn aluminum alloy or stainless steel is to reduce a welding point to improve the mechanical strength of the can 104. The prismatic battery cell 100 may be filled with an electrolyte. After electrolyte filling, the electrolyte cap 138 may be welded to the upper cap assembly 120 or a locking ball (not shown) may be forced into an opening of the electrolyte cap 138. The cell may have an overcharge safety device 134 that may disconnect current flow when high internal pressure is reached in the prismatic battery cell 100. A rise in pressure is usually a result of high temperatures.

According to an embodiment, the cathode terminal 128 may be provided in plural. For example, the cathode terminal 128 may include a first cathode terminal 128a in which at least a portion is exposed to the outside of the battery cell 100 and a second cathode terminal 128b connected to a cathode foil (e.g., the cathode foil 112 of FIG. 1). The second cathode terminal 128b may be electrically connected to the first cathode terminal 128a. For example, a portion of the second cathode terminal 128b may contact the first cathode terminal 128a.

According to an embodiment, the anode terminal 126 may be provided in plural. For example, the anode terminal 126 may include a first anode terminal 126a in which at least a portion is exposed to the outside of the battery cell 100 and a second anode terminal 126b connected to an anode foil (e.g., the anode foil 110 of FIG. 1). The second anode terminal 126b may be electrically connected to the first anode terminal 126a. For example, a portion of the second anode terminal 126b may contact the first anode terminal 126a.

FIGS. 3A to 3F are a view illustrating an assembly process of an upper cap assembly and an electrode assembly according to an embodiment. A battery cell manufacturing process 300 may include an assembly process of the upper cap assembly 120 and the jelly roll 106.

Referring to FIG. 3A, a sealing tape 106a may be attached to the jelly roll 106. According to an embodiment, the sealing tape 106a can cover at least a portion of the jelly roll 106. According to an embodiment, the sealing tape 106a may seal a portion of the jelly roll 106.

Referring to FIG. 3B, the jelly roll 106 may be connected to the upper cap assembly 120. For example, a connection component for connecting the jelly roll 106 and the upper cap assembly 120 may be prepared. The upper cap assembly 120 may be closely attached to the jelly roll 106 using the connection component. For example, the cathode terminal 128 of the upper cap assembly 120 may be connected to the cathode foil 112 of the jelly roll 106, and the anode terminal 126 of the upper cap assembly 120 may be connected to the jelly roll 106. The cathode terminal 128 may be welded to the cathode foil 112 and the anode terminal 126 may be welded (e.g., ultrasonic-welded) to the anode foil 110.

Referring to FIG. 3C, at least a portion of the cathode terminal 128 may be masked. For example, the cathode connector mask 118 may be disposed to cover a portion of the cathode terminal 128. The cathode connector mask 118 may protect the cathode terminal 128. Although not shown, the description of the masking of the cathode terminal 128 may be applied to the anode terminal 126 as well.

Referring to FIG. 3D and/or FIG. 3E, tape may be attached to at least a portion of the cathode terminal 128 and the anode terminal 126. For example, the battery cell 100 may include welding tapes 118a, 118b, 118c, and 118d attached to at least a portion of the cathode terminal 128, the anode terminal 126, the cathode foil 112, and/or the anode foil 110. According to an embodiment, the welding tapes 118a, 118b, 118c, 118d may be attached to at least a portion of a joint portion of the cathode terminal 128, the anode terminal 126, the cathode foil 112, and/or the anode foil 110. As the joint portion is covered with the welding tapes 118a, 118b, 118c, and 118d, the cathode terminal 128 and the anode terminal 126 may be protected.

Referring to FIG. 3F, the anode foil 110 connected to the anode terminal 126 may be folded. For example, when the upper cap assembly 120 is disposed on the jelly roll 106, at least a portion of the anode foil 110 may be folded. Although not shown, when the upper cap assembly 120 is placed on the jelly roll 106, the cathode foil 112 may also be folded.

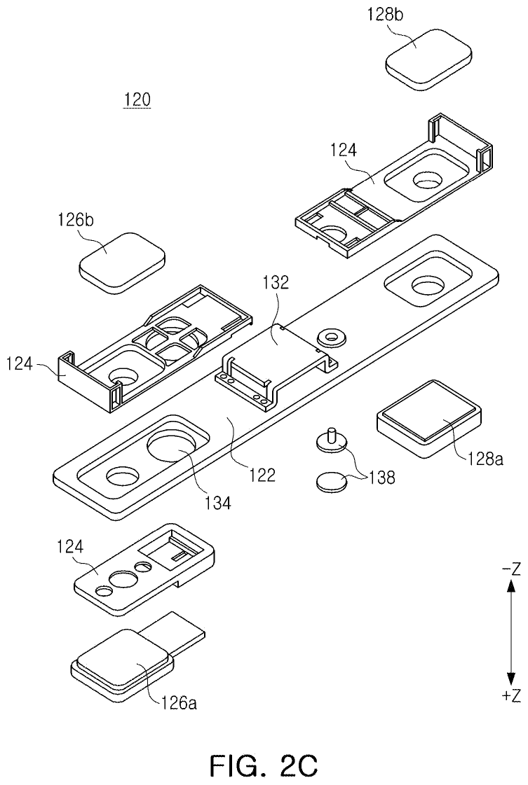

FIGS. 4A to 4F are a view illustrating an assembly process of an electrode assembly, a jelly roll bag, and a can. A battery cell manufacturing process 400 may include an assembly process of the jelly roll 106, the jelly roll bag 108, and the can 104.

Referring to FIG. 4A, an insulator 136 may be installed on the battery cell 100. For example, the insulator 136 may be disposed between the can 104 and the cap assembly 120.

Referring to FIG. 4B, the jelly roll bag 108 may be prepared. The jelly roll bag 108 may cover at least a portion (e.g., a side surface) of the jelly roll 106. The jelly roll 106 may be surrounded by the jelly roll bag 108. The jelly roll bag 108 may protect the jelly roll 106 from external impact. In FIG. 4B, a structure in which the jelly roll bag 108 is disposed on two side surfaces of the jelly roll 106 is shown, but the structure of the jelly roll bag 108 is not limited thereto. For example, according to an embodiment, the jelly roll bag 108 may be formed to cover four side surfaces of the jelly roll 106.

Referring to FIG. 4C, an insulator 108a may be attached to the jelly roll 106. According to an embodiment, in a state in which the jelly roll bag 108 is unfolded, the insulator 108a may be attached to a lower portion of the jelly roll 106. The insulator 108a may be referred to as a lower insulator.

Referring to FIG. 4D, at least some of the components of the battery cell 100 may be taped. For example, the battery cell 100 may include the upper cap assembly 120, the can 104, and/or at least one first tape 108b attached onto insulator 136, and/or a second tape 108c attached to a lower portion of the jelly roll bag 108 along a side portion of the insulator 136.

Referring to FIG. 4E, the jelly roll 106 may be inserted into the can 104. The jelly roll 106 and/or the jelly roll bag 108 may be inserted into the can 104.

According to an embodiment, the battery cell manufacturing process 400 may include a wetting process of the jelly roll 106. For example, the jelly roll 106 may be initially wetted by an electrolyte delivered through an electrolyte injection port. For example, partial vacuum may be formed in the prismatic battery cell 100, and a predetermined amount of electrolyte may be injected through the electrolyte injection port. The partial vacuum may improve the distribution and wetting of all layers within the jelly roll 106. Wetting of all layers within the jelly roll 106 may require a rolling or spinning protocol to enhance wetting.

According to an embodiment, the battery cell manufacturing process 400 may include a quality check process for the initial wetting process, such as checking a weight of the prismatic battery cell 100 immediately after charging. For example, a second electrolyte charging operation in which an electrolyte is charged to achieve a desired weight may be applied to the battery cell. According to an embodiment, the battery cell manufacturing process 400 may include a pre-formation process of charging the prismatic battery cell 100 and discharging gas.

Referring to FIG. 4F, the electrolyte injection port may be sealed. For example, the electrolyte cap 138 may be inserted into the electrolyte injection port.

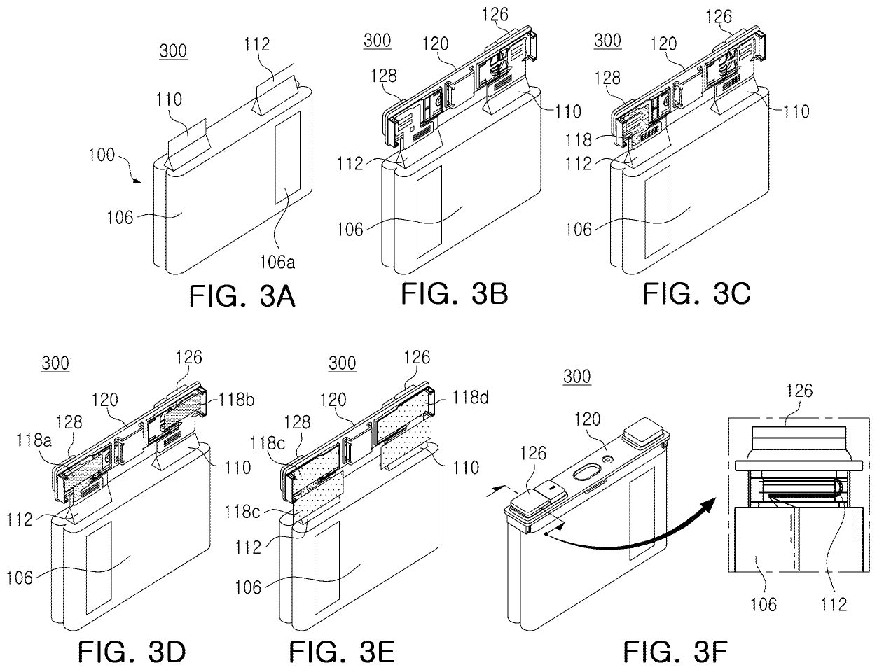

FIG. 5 illustrates a bulging can, according to an embodiment.

Referring to FIG. 5, the battery cell 100 may include a modified can 104. The description of the battery cell 100 and can 104 of FIG. 1 may be applied to a battery cell 100 and a can 104 of FIG. 5.

According to an embodiment, the can 104 of the battery cell 100 may be modified due to pressure accumulated inside the battery cell 100 (e.g., the jelly roll 106 of FIG. 1) during a charging or discharging process. For example, due to swelling of the jelly roll 106, at least a portion of the can 104 (e.g., the wide surface 104a) may be modified (e.g., swelling). The modified can 104 may include a bulging region 500. The bulging region 500 may be referred to a portion of can 104 that is swelled by increased temperature and/or pressure during charging or discharging. For example, the can 104 may include a wide surface 104a and a narrow surface 104b, shorter than the wide surface 104a. The bulging region 500 may include a swelling portion 504 protruding outwardly of the can 104 from the wide surface 104a of the can 104. The bulging region 500 may be formed by receiving pressure from the jelly roll 106 in which an inner surface of the can 104 is swelled. The battery cell 100 in which the bulging region 500 is formed may damage other parts of a battery device (e.g., a battery module and/or a battery pack) in which the battery cell 100 is accommodated.

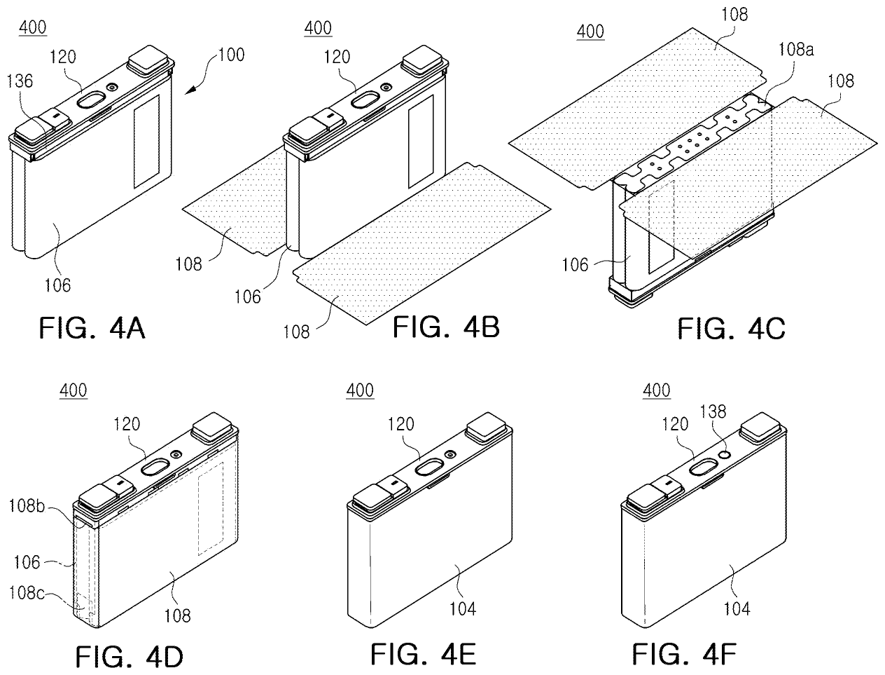

FIG. 6 is a view for illustrating an impact extrusion process for forming a case of a prismatic battery cell according to an embodiment. For example, FIG. 6 illustrates five stages of an impact extrusion manufacturing process for converting an aluminum slug 600 into a can 104 for a prismatic battery cell 100.

A first phase is an aluminum slug 600. The aluminum slug 600 may be extruded and transformed into a first workpiece 602.

The first workpiece 602 may be drawn into a second workpiece 604 through ironing. At least a portion of a second workpiece 604 may be cut and transformed into a third workpiece 606. The third workpiece 606 may be trimmed and polished to a final state of the can 104. For example, an unintended protrusion formed on a surface of the third workpiece 606 may be removed. The first workpiece 602, the second workpiece 604, and the third workpiece 606 may be formed during processing of the aluminum slug 600 into the can 104. In an embodiment, the first workpiece 602, second workpiece 604, and third workpiece 606 may be referred to as a first level, a second level, and a third level, respectively.

In FIG. 6, the can 104 made of aluminum is described, but a material of the can 104 is not limited thereto. For example, the can 104 may include the other metal (e.g., titanium).

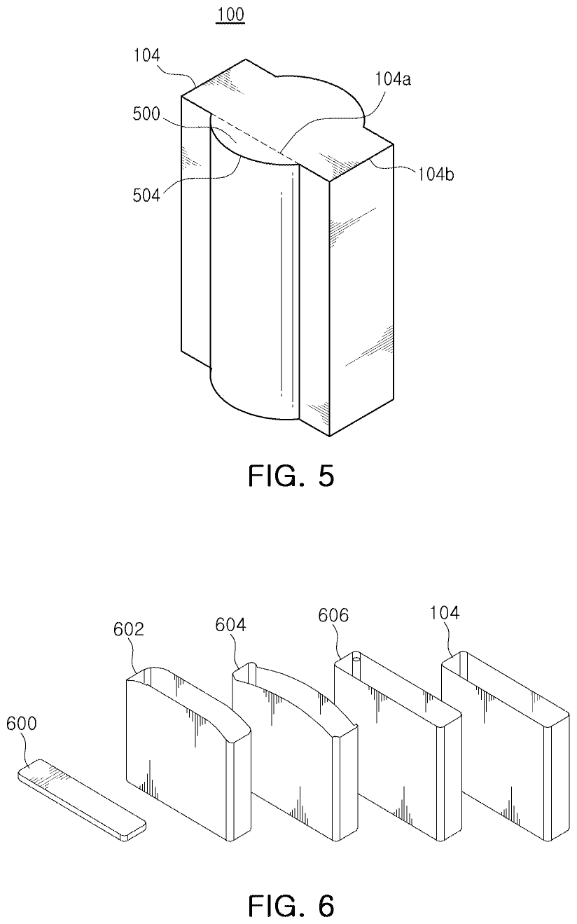

FIGS. 7A and 7B are views for illustrating an impact extrusion process according to an embodiment. For example, FIGS. 7A and 7B illustrate two cross-sections of an impact extrusion process. An aluminum slug 600 may be disposed between a mandrel 700 and a driving slug 702. The driving slug 702 may be moved in a direction of an arrow until reaching a position illustrated in FIG. 7B, typically using a pneumatic or hydraulic press. When the driving slug 702 reaches the position illustrated in FIG. 7B, the aluminum slug 600 may be formed as a workpiece (e.g., the first workpiece 602 of FIG. 6) for producing a can 104 for a prismatic battery cell 100. A size and shape of mandrel 700 and/or driving slug 702 may be selectively designed. For example, a length of the mandrel 700 may be changed according to a final shape of the prismatic battery cell 100.

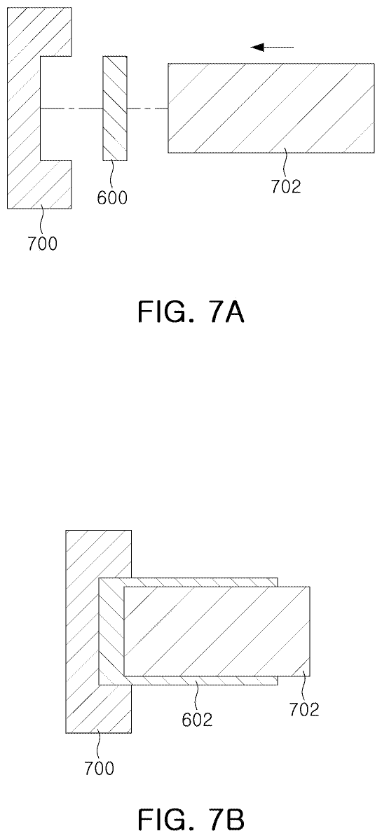

FIGS. 8A and 8B are a diagram for illustrating an ironing process.

In an embodiment, the can 104 may be further formed through ironing after the impact extrusion process. For example, an ironing process may be further performed on the second workpiece 604 manufactured by the impact extrusion process of FIG. 7.

The ironing process may refer to a process of pressing a first workpiece (e.g., the first workpiece 602 of FIG. 7B) using an iron 800, to deform the shape of the first workpiece 602. For example, a thickness of at least a portion of the second workpiece 604a and 604b may be different from a thickness of the first workpiece 602.

The iron 800 may press the can 104 to draw a material in a given direction, so that a thinner, larger, and more uniform can 104 may be produced. In an embodiment, an internal mold 806 may be disposed inside the can 104, and the iron 800 may apply pressure to the can 104 outside the can 104. An un-ironed portion of the prismatic cell can 104 is illustrated in the second workpiece 604b. Referring to FIGS. 8A and 8B, the iron 800 may move from a lower portion of the can 104 to an upper portion thereof. The iron 800 may deform a shape of the can 104 by lifting a material of the second workpiece 604a and 604b. For example, the iron 800 may produce an ironed portion of the prismatic cell can 104 illustrated in the second workpiece 604b. A thickness and/or shape of at least a portion of the can 104 may be modified in an ironing process.

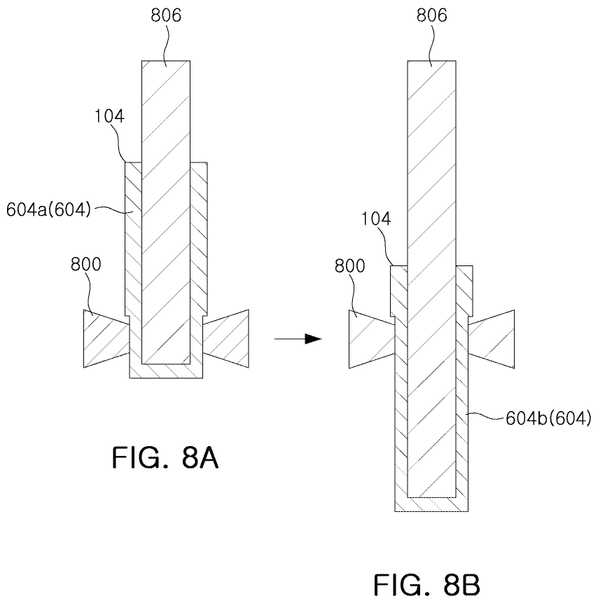

FIG. 9 illustrates a can including a support rod according to an embodiment.

Referring to FIG. 9, the can 104 may include a frame 109 forming an accommodation space S and a support rod 900 mounted on the frame 109. The description of the can 104 of FIG. 1 may be applied to a can 104 of FIG. 9.

The support rod 900 may be added to increase structural strength of can 104 of battery cell 100. In an embodiment, the support rod 900 may be referred to as a corner support rod. The description of the can 104 of FIG. 1 may be applied to a frame 109 of FIG. 9.

The support rod 900 may include a plurality of support rods 900a, 900b, 900c, and 900d. Each of the plurality of support rods 900a, 900b, 900c, and 900d may form a corner portion 104c of the can 104. The support rod 900 may be disposed on a corner portion of the frame 109. For example, the corner portion 104c of the can 104 may be referred to as a corner portion of frame 109 and a support rod 900.

A material of the support rod 900 may be selectively designed. In an embodiment, the support rod 900 may be formed of the same material (e.g., aluminum) as the remaining portion (e.g., the frame 109) of the can 104. Alternatively, the support rod 900 may be formed of a different material than the frame 109 (e.g., steel).

A shape of the support rod 900 may be selectively designed. For example, the support rod 900 may have a shape or geometry corresponding to an inner surface of the frame 109.

FIG. 9 illustrates a first method of adding a structure to a can 104 of a battery cell (e.g., the battery cell 100 of FIG. 1). According to an embodiment, the support rod 900 may be disposed on a frame 109 with robotic control insertion. The inserted support rod 900 may be tapped, welded or epoxied in a predetermined position.

The can 104 may include a plurality of corner portions 104c and a planar portion 104d disposed between the plurality of corner portions 104c.

In an embodiment, as a thickness of the corner portion 104c is formed to be greater than a thickness of the planar portion 104d, structural strength of the can 104 may be improved. As the structural strength of the can 104 is improved, bulging and/or swelling of the battery cell 100 may be reduced.

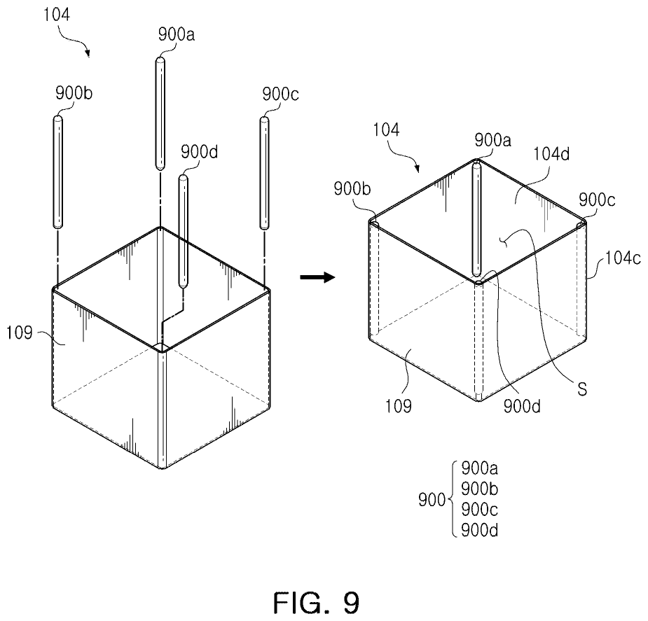

FIG. 10 illustrates a can including a support sleeve, according to an embodiment.

Referring to FIG. 10, a can 104 may include a frame 109 forming an accommodation space S and a support sleeve 1000 mounted on the frame 109. The description of the can 104 of FIG. 1 may be applied to the can 104 of FIG. 10.

To increase the structural strength of the can 104 of the battery cell (e.g., the battery cell 100 of FIG. 1), a support sleeve 1000 may be added. In an embodiment, the support sleeve may be referred to as a side support sleeve. The description of the frame 109 of FIG. 9 may be applied to the frame 109 of FIG. 10.

A support sleeve 1000 may form at least a side surface of the can 104. For example, the support sleeve 1000 may be disposed between an inner surface of the frame 109 and the jelly roll 106.

According to an embodiment, the can 104 may include a wide surface 104a and a narrow surface 104b, shorter than the wide surface 104a.

The can 104 may form an accommodation space S for accommodating a jelly roll (e.g., the jelly roll 106 of FIG. 1). For example, the can 104 may include a wide surface 104a and a narrow surface 104b surrounding at least a portion of the accommodation space S. In an embodiment, each of the wide surface 104a and the narrow surface 104b may be referred to as a first side surface and a second side surface.

The can 104 may include a plurality of corner portions 104c and a planar portion 104d disposed between the plurality of corner portions 104c. The corner portion 104c may be disposed between the wide surface 104a and the narrow surface 104b. At least a portion of the wide surface 104a and at least a portion of the narrow surface 104b may form a planar portion 104d.

According to an embodiment the support sleeve 1000 may be disposed on at least a portion of the planar portion 104d of the can 104. For example, the support sleeve 1000 may be attached to both wide surfaces 104a. For example, the support sleeve 1000 may include a first support sleeve 1000a and a second support sleeve 1000b, facing each other.

In an embodiment, a support sleeve 1000 is added to a wall of the can 104 for the battery cell 100. Since the support sleeve 1000 is disposed on the can 104, structural strength of the can 104 may be improved. Both wide surfaces 104a of the can 104 may be provided with pressure by an electrode assembly (e.g., the jelly roll 106 of FIG. 1). For example, when the jelly roll 106 swells, the pressure of the jelly roll 106 may be concentrated at one point on the wide surface 104a. As the support sleeve 1000 is disposed on both wide surfaces 104a, bulging and/or swelling of the can 104 may be reduced.

A material of the support sleeve 1000 may be selectively designed. In an embodiment, the support sleeve 1000 may be formed of the same material (e.g., aluminum) as the remaining portion of the can 104 (e.g., a frame 109). Alternatively, support sleeve 1000 may be formed of a different material than frame 109 (e.g., steel).

A shape of the support sleeve 1000 may be selectively designed. For example, the support sleeve 1000 may have a shape corresponding to an inner surface of the frame 109 or geometry.

FIG. 10 illustrates a second method of adding a structure to a prismatic battery cell 102. A support sleeve 1000 may be attached to an inner surface of frame 109. According to an embodiment, the support sleeve 1000 may be epoxied or welded in a predetermined position.

According to an embodiment (not shown), the support sleeve 1000 of FIG. 10 may be used with the support rod 900 of FIG. 9. For example, the battery cell 100 of an embodiment may include the support rod 900 and the support sleeve 1000 together.

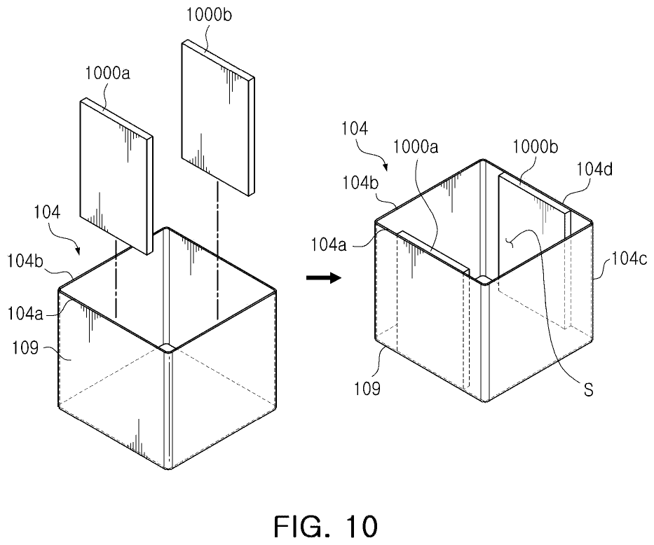

FIG. 11 illustrates a battery cell having a protective bag, according to an embodiment.

Referring to FIG. 11, a battery cell 100 may include a can 104, an electrode assembly (e.g., the jelly roll 106 of FIG. 1), and a protective bag 1100. The description of the can 104 and the jelly roll 106 forming the accommodation space S of FIG. 1 may be applied to the can 104 and the jelly roll 106 of FIG. 11.

According to an embodiment, the protective bag 1100 may surround at least a portion of the jelly roll 106. The protective bag 1100 may include holes for exposing a cathode terminal 128 and an anode terminal 126.

The protective bag 1100 may be formed of a non-conductive material. In an embodiment, the protective bag 1100 may be formed of a material such as Kevlar or other nanomaterial designs. The protective bag 1100 may protect the battery cell 100 in two ways. For example, the protective bag 1100 may protect an interior of the jelly roll 106 from puncture damage, such as may be seen in an auto accident involving an electric vehicle. By protecting the jelly roll 106, an internal short circuit of the jelly roll 106 can be prevented. As another example, the protective bag 1100 may accommodate the jelly roll 106 in a given volume, not exceeding a capacity of the can 104 of the prismatic battery cells 100, to prevent swelling of the jelly roll 106 and/or battery cell 100.

According to an embodiment (not shown), the protective bag 1100 of FIG. 11 may be used with the support sleeve 1000 of FIG. 10 and/or the support rod 900 of FIG. 9.

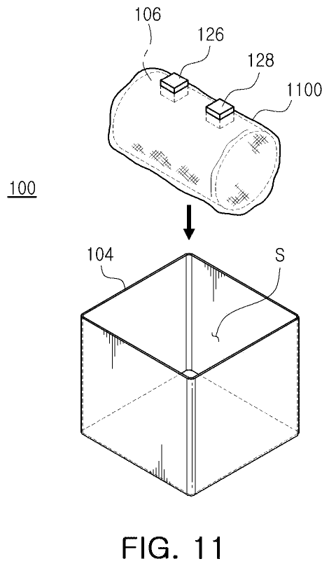

FIG. 12 illustrates a can including a protruding region, according to an embodiment.

The description of the configuration of the can 104 of FIG. 1 or FIG. 10 (e.g., the wide surface 104a, the narrow surface 104b, the corner portion 104c, and the planar portion 104d) may be applied to a can 104 of FIG. 12.

Referring to FIG. 12, the can 104 may be manufactured using an impact extrusion process (e.g., the impact extrusion process of FIGS. 7A and 7B). For example, FIG. 12 illustrated a wall-modified driving slug 1200 designed to create a can 104 of prismatic battery cells 100, which is more resistant to bulging via impact extrusion. The wall-modified driving slug 1200 is a driving slug 1200 that has been modified in at least one of several ways to increase strength, structural integrity, or resistance to bulging of the prismatic battery cell can 104. The description of the drive slug 702 of FIGS. 7A and/or 7B may be applied to the driving slug 1200 of FIG. 12.

In an embodiment, the modified driving slug 1200 may include two cutouts 1202. The cutout 1202 may be a groove or recess formed on a side surface of the driving slug 1200. For example, the cutout 1202 may be referred to as a side groove.

According to an embodiment, the can 104 may be manufactured using a driving slug 1200. For example, the cutout 1202 can create two reinforcing portions 104e in the can 104 of the prismatic battery cell (e.g., the battery cell 100 of FIG. 1) during an impact extrusion process.

According to an embodiment, the can 104 may be formed to correspond to the shape of the driving slug 1200. For example, the can 104 may include a reinforcing portion 104e formed to correspond to the cutout 1202. The reinforcing portion 104e may protrude inwardly of the can 104 from the planar portion 104d of the can 104. For example, the reinforcing portion 104e may protrude toward a jelly roll (e.g., the jelly roll 106 of FIG. 1) from an inner surface of the planar portion 104d. The reinforcing portion 104e of the can 104 may be referred to as a reinforcing region or a protruding region. According to an embodiment, the reinforcing portion 104e may be formed on an inner surface of the wide surface 104a.

According to an embodiment, a thickness of at least a portion of the planar portion 104d may be greater than a thickness of each of the plurality of corner portions 104c. For example, a first width w1 of the can 104 where the reinforcing portion 104e is located may be thicker than a second width w2 of the planar portion 104d where the reinforcing portion 104e is not located. The second width w2 may be substantially the same as the thickness of the corner portion. According to an embodiment, the reinforcing portion 104e may improve structural strength of the can 104. Bulging and/or swelling of the can 104 may be reduced by the reinforcing portion 104e. The reinforcing portion 104e may be provided with pressure by an electrode assembly (e.g., the jelly roll 106 of FIG. 1). For example, when the jelly roll 106 swells, the reinforcing portion 104e may press a portion (e.g., a planar portion) of the jelly roll 106. The reinforcing portion 104e may uniformly form an interface between components of the jelly roll 106 (e.g., a positive electrode plate, a negative electrode plate, and a separator), so that a lifespan of the jelly roll 106 may be improved.

According to an embodiment (not shown), together with the structure of the can 104 of FIG. 12 (e.g., the reinforcing portion 104e), the battery cell 100 may include the protective bag 1100 of FIG. 11, and the support sleeve of FIG. 10, and/or the support rod 900 of FIG. 9.

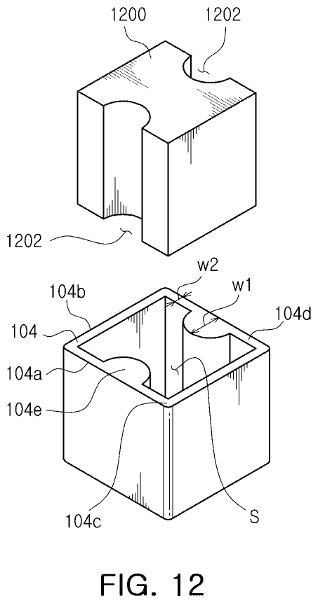

FIG. 13 illustrates a can including a modified corner portion.

Referring to FIG. 13, a can 104 may be manufactured using an impact extrusion process (e.g., the impact extrusion process of FIGS. 7A and 7B). The description of the configuration of the can 104 of FIG. 1, FIG. 10 or FIG. 12 (e.g., the wide surface 104a, the narrow surface 104b, the corner portion 104c, and the planar portion 104d) may be applied to the can 104 of FIG. 13.

For example, FIG. 13 illustrates a corner-modified driving slug 1300 for impact extrusion of a can 104 of a prismatic battery cell (e.g., the battery cell 100 of FIG. 1), which is more resistant to bulging via impact extrusion. The corner-modified driving slug 1300 of FIG. 13 may be a structure having a corner portion cut off from a standard driving slug 702 (e.g., the driving slug 702 of FIGS. 7A and 7B).

For example, the driving slug 1300 of FIG. 13 may be pressed into a mandrel (e.g., the mandrel 700 of FIG. 7A) as a process for forming an aluminum slug (e.g., the aluminum slug of FIG. 6 600) into a prismatic battery cell can 104. The corner-modified driving slug 1300 may include four corner deformation portions 1302, which allow more aluminum slugs 600 to be formed at an edge or a corner portion of the can 104 of a prismatic battery cell (e.g., the battery cell 100 in FIG. 1). The corner deformation portions 1300e may have a structure in which a portion of an outer surface 1300d of the driving slug 1300 is cut off. The corner deformation portions 1300e may be referred to as a chamfer structure. According to an embodiment, the can 104 may be formed to correspond to a shape of the driving slug 1300. For example, the can 104 may include a corner portion 104c formed to correspond to a corner deformation portion 1300e. A first thickness t1 of the corner portion 104c may be greater than a second thickness t2 of the planar portion 104d. Since the corner portion 104c is formed to be thicker than the planar portion 104d, structural rigidity of the can 104 may be improved.

According to an embodiment (not shown), together with a structure of the can 104 of FIG. 13 (e.g., the corner portion 104c), the battery cell 100 may include a structure of the can 104 of FIG. 12 (e.g., the reinforcing portion 104e), a protective bag 1100 of FIG. 11, the support sleeve 1000 of FIG. 10, and/or the support rod 900 of FIG. 9.

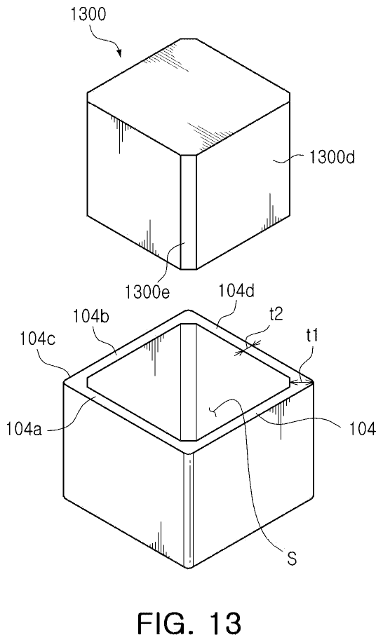

FIG. 14 illustrates a can manufactured by a first ironing process according to an embodiment.

Referring to FIG. 14, a can 104 may be manufactured by an iron 800. The description of the can 104, the iron 800, and the inner mold 806 of FIG. 8A may be applied to a can 104, an iron 800, and an inner mold 806 of FIG. 14. According to an embodiment, a thickness of the can 104 may be modified using an iron 800. In an embodiment, the iron 800 may include a plurality (e.g., four) of irons. The iron 800 may include an upper left iron 801, a lower left iron 802, an upper right iron 803, and a lower right iron 804. The iron 800 may move along an outside of the can 104. When the iron 800 moves, the iron 800 may change a thickness of a surface of the can 104. In an embodiment, as the iron 800 moves from an upper portion or a lower portion of the can 104 to a flat surface thereof, the thickness of the can 104 of the battery cell 100 may be modified. A portion of the can 104 modified (e.g., reduction in thickness) by the iron 800 may be referred to as an ironing region 104g.

For example, one portion of the can 104 pressed by the iron 800 may be referred to as an ironing region, and the other portion of the can 104, not pressed by the iron 800 may be referred to as a protrusion 104f. In an embodiment, the protrusion 104f may protrude from an outer surface of the can 104 outwardly of the can 104. A thickness of the protrusion 104f may be greater than other portions of the wide surface 104a of the can 104. For example, the protrusion 104f may extend from the ironing region 104g. The thickness of the protrusion 104f may be greater than that of the ironing region 104g.

In an embodiment, the protrusion 104f and the ironing region 104g may be formed on the wide surface 104a of the can 104. Since the protrusion 104f is formed on the wide surface 104a, structural rigidity of the can 104 may be improved. The protrusion 104f may be located at a center of the wide surface 104a of the can 104.

The first ironing process may refer to a process of forming the protrusion 104f on the can 104 by using a plurality of irons 801, 802, 803, and 804 moving from a rim of the can 104 toward the planar portion.

According to an embodiment (not shown), together with a structure of the can 104 of FIG. 14 (e.g., the protrusion 104f), the battery cell 100 may include a structure of the can 104 of FIG. 14 (e.g., the corner portion 104c), a structure of the can 104 of FIG. 12 (e.g., the reinforcing portion 104e), the protective bag 1100 of FIG. 11, the support sleeve 1000 of FIG. 10, and/or the support rod 900 of FIG. 9.

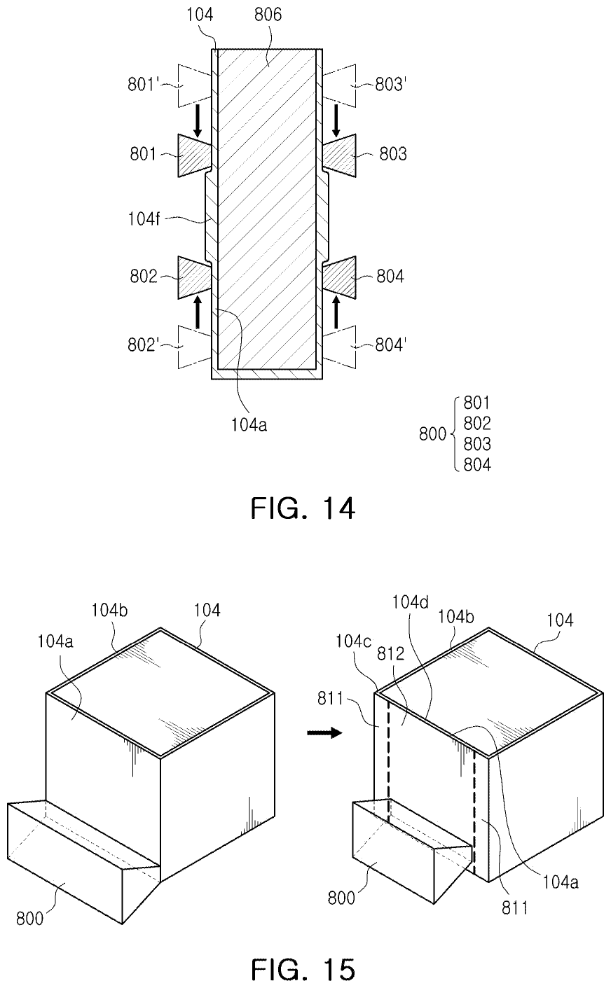

FIG. 15 illustrates a can formed by a second ironing process, according to one embodiment.

Referring to FIG. 15, a can 104 may be manufactured by an iron 800. The description of the can 104 and the iron 800 of FIG. 8A may be applied to the can 104 and the iron 800 of FIG. 15.

A thickness of a corner portion 104 may be increased by a second ironing process. For example, the can 104 may include an ironing region 812 pressed by the iron 800 and a reinforcing region 811 not facing the iron 800. The reinforcing region 811 may form at least a portion of the corner portion 104c of the can 104. The ironing region 812 may form at least a portion of a planar portion 104d of the can 104. A width of the iron 800 may be narrower than a width of the wide surface 104a of the can 104. A thickness and material amount of the reinforcing region 811 may be greater than a thickness and material amount of the ironing region 812.

As the reinforcing region 811 is formed in the corner portion 104c of the can 104, space utilization of the can 104 may be increased. For example, strength and/or structural integrity of the can 104 may be improved while minimizing a reduction in empty space for accommodating the electrode assembly (e.g., the jelly roll 106 of FIG. 1).

According to an embodiment (not shown), together with the reinforcing region 811 and the ironing region 812 of FIG. 15, the battery cell 100 may include a structure of the can 104 of FIG. 14 (e.g., a protrusion 104f), a structure of the can 104 of FIG. 13 (e.g., a corner portion 104c), a structure of the can 104 of FIG. 12 (e.g., a reinforcing region 104e), a protective bag 1100 of FIG. 11, and a support sleeve 1000 of FIG. 10 and/or a support rod 900 of FIG. 9.

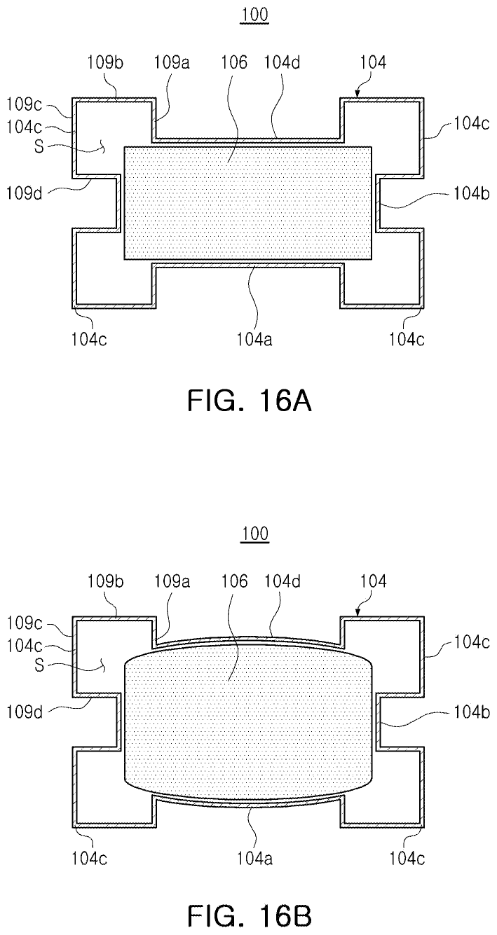

FIGS. 16A and 16B are schematic diagrams of a battery cell, according to an embodiment.

Referring to FIGS. 16A and 16B, the battery cell 100 may include a can 104 and a jelly roll 106.

The description of the battery cell 100, the can 104, and the jelly roll 106 of FIG. 1 may be applied to a battery cell 100, a can 104, and a jelly roll 106 of FIGS. 16A and 16B. The can 104 of FIGS. 16A and 16B may be manufactured using the process described in FIGS. 6, 7A, 7B, 8A, 8B, 12, 13, 14 and/or 15.

According to an embodiment, at least a portion of the can 104 may be formed to be modified based on swelling of the jelly roll 106. For example, the can 104 may include at least one buffer portion 107 formed on a frame (e.g., the frame 109 of FIG. 9). The buffer portion 107 may be manufactured using an ironing process and/or an impact extrusion process. For example, the buffer portion 107 may be a groove or a recess formed in a planar portion 104d of the can 104. For example, a first distance d1 between both buffer portions 107 may be shorter than a second distance d2 between both corner portions 104c.

When the jelly roll 106 swells, the buffer portion 107 may be in contact with the jelly roll 106. The planar portion 104d on which the buffer portion 107 is formed may be modified into a curved shape by the swelled jelly roll 106. The jelly roll 106 may be in contact with the planar portion 104d of the can 104, and apply pressure to the planar portion 104d.

According to an embodiment, the buffer portion 107 may be formed on a wide surface 104a and a narrow surface 104b. For example, the corner portion 104c of the can 104 may protrude from a planar portion 104d. In an embodiment, the corner portion 104c may include a first protruding region 109a extending substantially perpendicularly to a wide surface 104a from the planar portion 104d of the wide surface 104a, a second protruding region 109b extending substantially perpendicularly from the first protruding region 109a, a fourth protruding region 109d extending substantially perpendicularly to a narrow surface 104b, and a third protruding region 109c formed perpendicularly to the second protruding region 109b and the fourth protruding region 109d.

According to an embodiment, the buffer portion 107 may include a plurality of buffer portions 107a and 107b spaced apart from each other. For example, the buffer portion 107 may include a first buffer portion 107a and a second buffer portion 107b, disposed substantially parallel to the first buffer 107a. The buffer portion 107 may be closer to the jelly roll 106 than the corner portion 104c. For example, a first distance d1 between the first buffer portion 107a and the second buffer portion 107b may be shorter than a second distance d2 between the plurality of corner portions 104c.

According to an embodiment, the shape of the buffer portion 107 may be selectively designed. FIGS. 16A and 16B illustrate a structure in which the buffer portion 107 is formed on a wide surface 104a and a narrow surface 104b, but a structure of the can 104 is not limited thereto. According to an embodiment (not shown), the buffer portion 107 may be formed on the wide surface 104a, and may not be formed on the wide surface 104b. Since the buffer portion 107 is formed on the wide surface 104a, space utilization of the battery cell 100 may be increased.

According to an embodiment, the buffer portion 107 may absorb at least a portion of swelling of the jelly roll 106. Bulging of the battery cell 100 may be reduced by the buffer portion 107.

According to an embodiment (not shown), with a structure of the can 104 of FIG. 16 (e.g., a buffer portion 107), the battery cell 100 may include a structure of the can 104 of FIG. 15 (e.g., a reinforcing region 811 and an ironing region 812), a structure of the can 104 of FIG. 14 (e.g., a protrusion 104f), a structure of the can 104 of FIG. 13 (e.g., a corner portion 104c), a structure of the can 104 of FIG. 12 (e.g., a reinforcing portion 104e), a protective bag 1100 of FIG. 11, a support sleeve 1000 of FIG. 10 and/or a support rod 900 of FIG. 9.

As set forth above, according to an embodiment of the present disclosure, a battery cell may reduce bulging or swelling of the battery cell by using a battery cell having improved structural strength.

According to an embodiment of the present disclosure, a case may press an electrode assembly to improve lifespan and performance of the battery cell.

The functions performed in the processes and methods may be implemented in a different order. Furthermore, the outlined steps and operations are only provided as examples, and some of the steps and operations may be optional, combined into fewer steps and operations, or expanded into additional steps and operations without detracting from the essence of the disclosed embodiments.

What is claimed is:

1. A battery cell, comprising:
an electrode assembly; and
a case accommodating the electrode assembly,
wherein the case includes a plurality of corner portions and a planar portion located between the plurality of corner portions,
wherein the planar portion is configured to press the electrode assembly, when the electrode assembly swells.

2. The battery cell of claim 1, wherein the case comprises at least one support sleeve forming at least a portion of the planar portion.

3. The battery cell of claim 2, wherein the at least one support sleeve comprises steel.

4. The battery cell of claim 1, wherein the planar portion comprises a reinforcing portion protruding toward the electrode assembly.

5. The battery cell of claim 4, wherein the case is manufactured by an impact extrusion process using a driving slug including a cutout.

6. The battery cell of claim 1, wherein the planar portion comprises an ironing region and a protrusion extending from the ironing region and protruding outwardly of the case.

7. The battery cell of claim 1, wherein a thickness of at least a portion of the planar portion is greater than a thickness of each of the plurality of corner portions.

8. The battery cell of claim 1, wherein the case comprises a wide surface and a narrow surface, and
at least a portion of the wide surface is configured to press the electrode assembly, when the electrode assembly swells.

9. A battery cell, comprising:
an electrode assembly; and
a case accommodating the electrode assembly,
wherein the case includes a plurality of corner portions and a planar portion disposed between the plurality of corner portions,
wherein a first thickness of the corner portion is greater than a second thickness of the planar portion.

10. The battery cell of claim 9, wherein the corner portion comprises a plurality of support rods.

11. The battery cell of claim 9, wherein the case is manufactured by an impact extrusion process using a driving slug with a corner deformation portion.

12. The battery cell of claim 9, wherein the case comprises an ironing region formed on the planar portion, and a reinforcing region forming at least a portion of the corner portion and thicker than the ironing region.

13. A battery cell, comprising:
an electrode assembly; and
a case accommodating the electrode assembly,
wherein the case includes a plurality of corner portions and a planar portion located between the plurality of corner portions,
wherein the case includes a buffer portion formed on the planar portion, and configured to be swelled based on swelling of the electrode assembly.

14. The battery cell of claim 13, wherein the buffer portion comprises a first buffer portion and a second buffer portion disposed in parallel with the first buffer portion, and a first distance between the first buffer portion and the second buffer portion is shorter than a second distance between the plurality of corner portions.

15. The battery cell of claim 13, wherein the case comprises a wide surface and a narrow surface,
wherein the buffer portion is formed on the wide surface.
